(19) United States
(12) Patent Application Publication
(10) Pub. No.: US 2015/0145637 A1
(43) Pub. Date: May 28, 2015

(54) PROTECTION ELEMENT

(71) Applicant: DEXERIALS CORPORATION, Tokyo (JP)

(72) Inventors: Kyoko Nitta, Tochigi (JP); Koichi Mukai, Tochigi (JP); Yuji Furuuchi, Tochigi (JP)

(21) Appl. No.: 14/408,705

(22) PCT Filed: Jul. 2, 2013
(86) PCT No.: PCT/JP2013/068083

§ 371 Date: Dec. 17, 2014

(30) Foreign Application Priority Data
Jul. 12, 2012 (JP) 2012-156308

(51) Int. Cl. H01H 85/00; H01H 85/055

(52) U.S. Cl. CPC H01H 85/0052; H01H 85/055
USPC 337/184

(57) ABSTRACT

A protection element wherein variations in fusing characteristics are improved by making the amount of a flux applied on a fusible conductor uniform. The protection element includes: an insulating substrate; a heating element laminated on the insulating substrate and covered with an insulating member; first and second electrodes, formed at both ends of the insulating substrate; an internal heating-element electrode laminated on the insulating member so as to be superposed above the heating element; and a fusible conductor whose ends are connected to the first and second electrodes, and center portion of which is connected to the internal heating-element electrode. To both ends of the heating element, there are connected heating element electrodes to connect a power supply to generate heat by passing electric current through the heating element. In the fusible conductor, a depression portion opened upward is formed at a position to be superposed above the heating element.

### FIELD OF THE INVENTION

The present invention relates to a protection element configured to protect a circuit connected on a current path by fusing the current path.

The present application asserts priority rights based on JP Patent Application 2012-156308 filed in Japan on Jul. 12, 2012. The total contents of disclosure of the patent application of the senior filing date are to be incorporated by reference into the present application.

### BACKGROUND OF THE INVENTION

Most of secondary batteries, which are capable of being charged and thereby repeatedly used, are processed to be in the form of a battery pack and provided to users. Particularly in a lithium ion secondary battery having a high weight energy density, in order to secure the safety of users and electronic devices, some protection circuits for overcharge protection, overdischarge protection, and the like are generally built in a battery pack, and the lithium ion secondary battery has a function interrupting the output of the battery pack in a predetermined case.

In many electronic devices using a lithium ion secondary battery, the output is turned on and off using an FET switch built in a battery pack, whereby an overcharge protection operation or an overdischarge protection operation for the battery pack is performed. However, in the case where the FET switch is short-circuited and broken due to some reason; in the case where impression of a lightning surge or the like causes a high current to instantly flows; or in the case where an output voltage extraordinarily decreases due to the life of a battery cell, or, on the contrary, an excessive voltage is outputted, the battery pack and the electronic device must be protected from accidents, such as a fire accident. Therefore, in order to safely interrupt the output of a battery cell in any thus-postulated abnormal situation, there is used a protection element comprising a fuse element having a function of interrupting a current path in response to an external signal.

As disclosed in Patent Literature 1, for such protection element of a protection circuit for lithium ion secondary batteries and the like, there has been generally employed a structure in which the protection element has a heating element inside the protection element and a fusible conductor on a current path is fused by heat of this heating element.

### PRIOR-ART DOCUMENTS

### Patent Document

PTL 1: Japanese Patent Application Laid-Open No. 2010-3665

### SUMMARY OF THE INVENTION

In a protection element disclosed in Patent Literature 1, a flux is applied to the surface of a fusible conductor (fuse) made of a low melting point metal in order to prevent oxidization, to accelerate the fusion-cutting of the fusible conductor, and to improve the fusing characteristics of the fusible conductor. Furthermore, in order to ensure the quality of the protection element, a cover member is provided to cover a substrate constituting the protection element. The uniform application of a flux to a predetermined portion on the fusible conductor allows the fusible conductor at the portion to be uniformly molten, thereby accelerating the cutting, whereby variations in fusing characteristics of the fusible conductor are reduced. Therefore, in order to hold an applied flux and make the amount of the flux on the fusible conductor uniform, the cover member has a cylindrical projecting portion in the inner surface of the cover member so that the projecting portion surrounds a center portion of the fusible conductor.

However, in the case where the cylindrical projecting portion is arranged on the fusible conductor, depending on the amount of the flux, the viscosity of the flux, or the contact area of the flux with the projecting portion, sometimes the flux is not sufficiently held on the fusible conductor and the uniform application of the flux is inhibited, whereby variations in fusing characteristics are caused. Furthermore, in order to form the cylindrical projecting portion, the cover member needs to have a height from the fusible conductor equivalent to the height of the projecting portion, consequently becoming a factor in limiting a reduction in thickness of the protection element.

Therefore, the prevent invention aims to achieve a protection element wherein variations in fusing characteristics are improved by making the amount of a flux applied on a fusible conductor uniform and maintaining a position of the flux fixed.

To solve the above-mentioned problems, a protection element according to the present invention comprises: an insulating substrate; a heating element laminated on the insulating substrate; first and second electrodes; an internal heating-element electrode electrically connected to the heating element and a current path between the first and the second electrodes; a fusible conductor connected over from the internal heating-element electrode to the first and the second electrodes, fusing the current path between the first and second electrodes by heating, and having a depression portion in a position to be thermally coupled to the heating element; and a flux applied to fill up the depression portion. Furthermore, the depression portion is formed and opened at a side for applying the flux. It should be noted that, as long as the heating element and the depression portion of the fusible conductor are thermally coupled to each other, a positional relationship therebetween is not limited, but, the heating body and the depression portion of the fusible conductor are preferably laminated in such a way that the distance therebetween is made as small as possible and the depression portion of the fusible conductor is superposed above the heating element.

### Effects of Invention

In the protection element according to the present invention, a fusible conductor has a depression portion in a position to be thermally coupled to a heating element, and a flux is held so as to fill up this depression portion, and therefore a molten state of the fusible conductor in a position in which the fusible conductor is thermally coupled to the heating element is made uniform, thereby accelerating the cutting of the fusible conductor, whereby variations in fusing characteristics are reduced.

### BRIEF DESCRIPTION OF DRAWINGS

FIG. 1A is a plan view of a protection element according to the present invention. FIG. 1B is a cross-sectional view along line AA′ of FIG. 1A, wherein a cover for protection is attached to the protection element illustrated in FIG. 1A.

FIG. 2A is a plan view of a protection element of another embodiment according to the present invention. FIG. 2B is a cross-sectional view along line AA′ of FIG. 2A.

FIG. 3 is a cross-sectional view to explain the height reduction of a protection element according to the present invention by comparing the protection element with a protection element according to a prior art. FIG. 3A shows a height comparison between the protection elements mounted without a cover attached thereto, meanwhile FIG. 3B shows a height comparison between the protection elements mounted with a cover attached thereto.

FIG. 4A is a plan view of a protection element of another embodiment according to the present invention. FIG. 4B is a cross-sectional view along line AA′ of FIG. 4A.

FIG. 5A is a plan view of a protection element of another embodiment according to the present invention. FIG. 5B is a cross-sectional view along line AA′ of FIG. 5A.

FIG. 6A is a plan view of a protection element of another embodiment according to the present invention. FIG. 6B is a cross-sectional view along line BB′ of FIG. 6A.

FIG. 7 is a block diagram illustrating an example application of a protection element according to the present invention.

FIG. 8 illustrates a circuit configuration example of a protection element according to the present invention.

FIG. 9A to FIG. 9C are schematic cross-sectional views for explaining a procedure to form a depression portion in a fusible conductor of a protection element according to the present invention.

FIG. 10A to FIG. 10C are schematic cross-sectional views for explaining a procedure to form a depression portion (a through hole) in a fusible conductor of a protection element of another embodiment according to the present invention.

FIG. 11A is a plan view illustrating a modified example of a protection element of an embodiment according to the present invention. FIG. 11B is a cross-sectional view along line AA′ of FIG. 11A.

FIG. 12A is a plan view illustrating another modified example of a protection element of an embodiment according to the present invention. FIG. 12B is a cross-sectional view along line AA′ of FIG. 12A.

FIG. 13A is a plan view illustrating another modified example of a protection element of an embodiment according to the present invention. FIG. 13B is a cross-sectional view along line AA′ of FIG. 13A.

FIG. 14A is a plan view illustrating another modified example of a protection element of an embodiment according to the present invention. FIG. 14B is a cross-sectional view along line AA′ of FIG. 14A.

FIG. 15A is a plan view illustrating another modified example of a protection element of an embodiment according to the present invention. FIG. 15B is a cross-sectional view along line AA′ of FIG. 15A.

FIG. 16A is a plan view illustrating another modified example of a protection element of an embodiment according to the present invention. FIG. 16B is a cross-sectional view along line AA′ of FIG. 16A.

FIG. 17A is a plan view illustrating another modified example of a protection element of an embodiment according to the present invention. FIG. 17B is a cross-sectional view along line AA′ of FIG. 17A.

FIG. 18A is a plan view illustrating another modified example of a protection element of an embodiment according to the present invention. FIG. 18B is a cross-sectional view along line AA′ of FIG. 18A.

FIG. 19A is a plan view illustrating another modified example of a protection element of an embodiment according to the present invention. FIG. 19B is a cross-sectional view along line AA′ of FIG. 19A.

### DETAILED DESCRIPTION OF THE INVENTION

Hereinafter, embodiments according to the present invention will be explained in detail with reference to the drawings. It should be noted that the present invention is not limited only to the following embodiments, and it is a matter of course that various changes can be made within the scope not deviating from the gist of the present invention.

[Configuration and Operation of Protection Element]

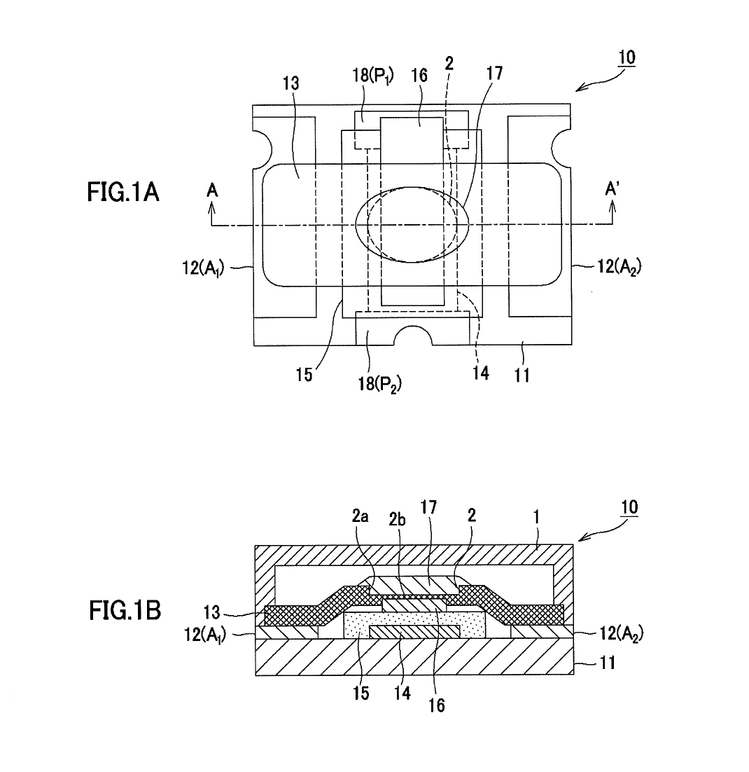

As illustrated in FIG. 1A and FIG. 1B, a protection element 10 comprises: an insulating substrate 11; a heating element 14 laminated on the insulating substrate 11 and covered with an insulating member 15; electrodes 12 (A1) and 12 (A2) formed at both ends of the insulating substrate 11; an internal heating-element electrode 16 laminated on the insulating member 15 so as to be superposed above the heating element 14; and a fusible conductor 13 both ends of which are connected to the electrodes 12 (A1) and 12 (A2), meanwhile a center portion of which is connected to the internal heating-element electrode 16. To both ends of the heating element 14, there are connected heating-element electrodes 18 (P1) and 18 (P2) which are to connect a power supply in order to generate heat by passing an electric current through the heating element 14. In the fusible conductor 13, a depression portion 2 opened upward is formed in a position to be superposed above the heating element 14. The depression 2 is a cylindrical hole portion composed of a wall portion 2a and a bottom portion 2b. Furthermore, a flux 17 is applied so as to fill up the depression portion 2 of the fusible conductor 13. As illustrated in FIG. 1B, a cover 1 is used for protection of the inside of the protection element 10 and made of an insulating material. For example, insulating materials having a predetermined heat resistance, such as liquid crystal polymer, glass epoxy, and ceramics, may be used. It should be noted that the shape of the depression portion 2 is not limited to a cylindrical shape, but may be a spherical shape, and furthermore, various shapes may be chosen in order to hold the flux 17 as mentioned later.

A quadrangular insulating substrate 11 is made of, for example, an insulative material, such as alumina, glass ceramics, mullite, or zirconia. Besides, there may be used a material used for printed-circuit boards, such as a glass epoxy board and a phenol board, but, it is necessary to care about a temperature for fusion-cutting.

The heating element 14 is made of an electrically conductive material, such as W, Mo, or Ru, having a comparatively high resistance and generating heat when electric current is made to flow therethrough. The heating element 14 is formed in such a manner that a powder of an alloy, composite, or compound of the above-mentioned materials is mixed with a resin binder and the like and made into a paste, and, using the obtained paste, a pattern is formed on the insulating substrate 11 by screen printing technique, and baking is performed.

The insulating member 15 is arranged so as to cover the heating element 14, and the internal heating-element electrode 16 is arranged so as to face the heating element 14 via the insulating member 15. One end of the internal heating-element electrode 16 is connected to one of the heating-element electrodes 18. Furthermore, one end of the heating element 14 is connected to another one of the heating-element electrodes 18.

It is beneficial that the fusible conductor 13 is made of an electrically conductive material which is fused by a predetermined electric power and heat, and, for example, a Bi—Pb—Sn alloy, a Bi—Pb alloy, a Bi—Sn alloy, a Sn—Pb alloy, a Pb—In alloy, a Zn—Al alloy, an In—Sn alloy, a Pb—Ag—Sn alloy, and the like may be used.

Furthermore, the fusible conductor 13 may be a layered body composed of a high melting point metal layer made of Ag, Cu, or a metal containing Ag or Cu as a main component and a low melting point metal layer made of a Pb-free solder containing Sn as a main component, or the like.

At the time of the production of the protection element 10, the flux 17 may have a low viscosity or may have a certain degree of viscosity.

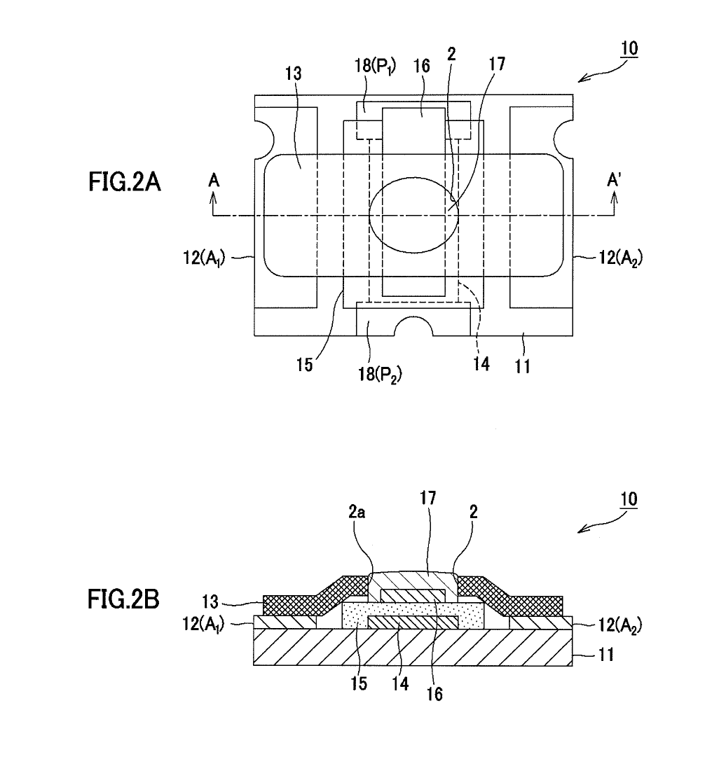

As illustrated in FIG. 2A and FIG. 2B, the depression 2 formed in the fusible conductor 13 may be a through hole cylindrically penetrating therethrough. The through hole has a wall portion 2a.

The flux 17 is applied to fill up the depression portion 2 which is a cylindrical hole portion or a through hole, whereby the application position of the flux 17 is maintained in a position in which the flux 17 is superposed above the heating element 14.

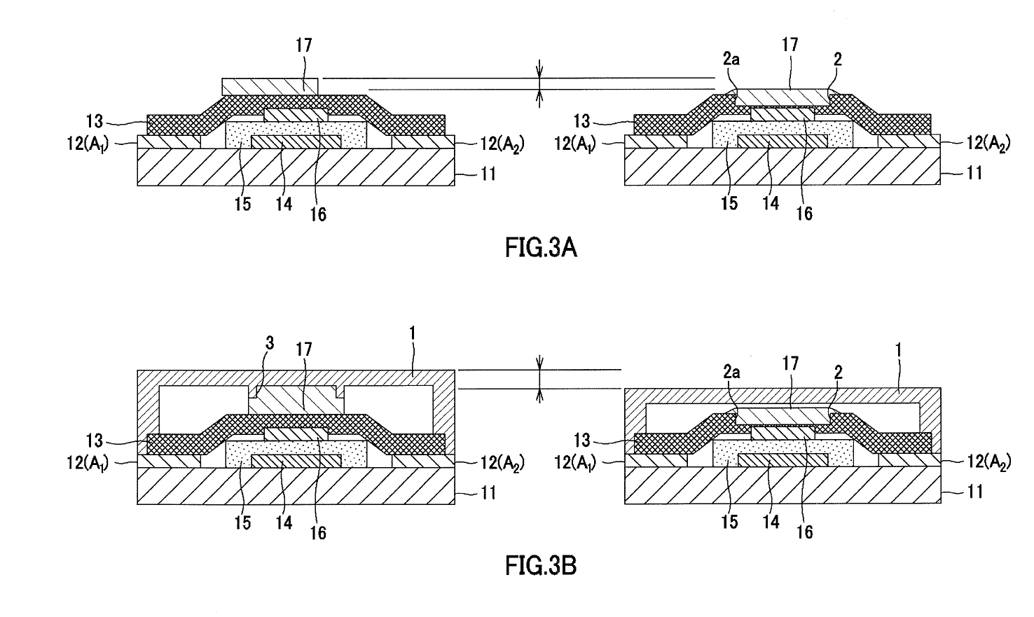

In a protection element according to a prior art illustrated in a figure on the left of FIG. 3A, the flux 17 is only applied on a fusible conductor, and therefore, the flux 17 cannot be held in a position to be superposed above a heating element. Furthermore, at least the application thickness of the flux 17 applied is added to the mounting height of the protection element. On the other hand, in the protection element according to the present invention illustrated in a figure on the right of FIG. 3A, the flux 17 is applied so as to fill up the depression 2, and hence, the flux 17 is held in a predetermined position, and the mounting height can be reduced by the equivalent of the application thickness of the flux 17, compared to the mounting height of the protection element according to the prior art.

Furthermore, as illustrated in a figure on the left of FIG. 3B, in a protection element according to a prior art in which a projecting portion is formed in the inner surface of a cover 1, a flux 17 can be held in a position to be superposed above a heating element. However, an additional mounting-height of the protection element equivalent to at least the height of the projection portion 3 is required. On the other hand, in a protection element according to the present invention illustrated in a figure on the right of FIG. 3B, since a flux 17 can be held in a depression portion 2, a cover 1 does not need to have a projecting portion 3 for holding the flux 17. Thus, the protection element according to the present invention can achieve to reduce the mounting height by the equivalent of the height of the projecting portion in the inner surface of the cover, compared to the protection element according to the prior art.

The configuration of the protection element 10 is not limited to the configuration mentioned above. Particularly, it is beneficial that the depression portion 2 of the fusible conductor 13 and the heating element 14 are thermally bonded, thereby allowing heat generation by the heating element 14 to fuse the fusible conductor 13.

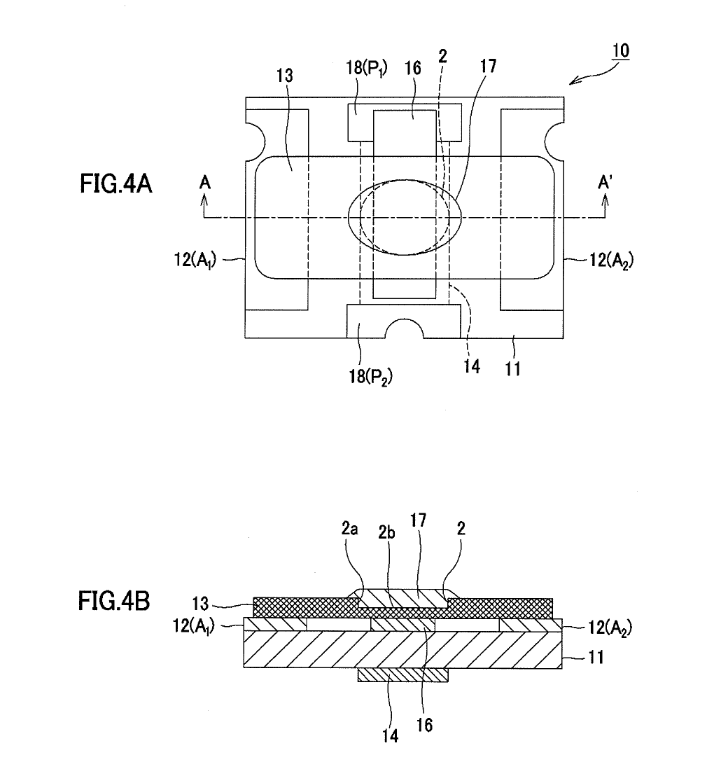

As illustrated in FIG. 4A and FIG. 4B, a protection element 10 may comprise: an insulating substrate 11 laminated on a heating element 14; an internal heating-element electrode 16 drawn out from the heating element 14 and arranged on the insulating substrate 11; and a fusible conductor 13 arranged over a range, from the internal heating-element electrode 16 to electrodes 12 (A1) and 12 (A2) and connected thereto. The heating element 14 and the fusible conductor 13 are arranged so as to make the insulating substrate 11 serve also as an insulating member, whereby the insulating member 15 illustrated in FIG. 1 and other figures can be omitted, and consequently the protection element 10 can be made still thinner. Furthermore, since there is no step of laminating the insulating member 15, the production process is simplified and shortened, thereby leading to cost reduction.

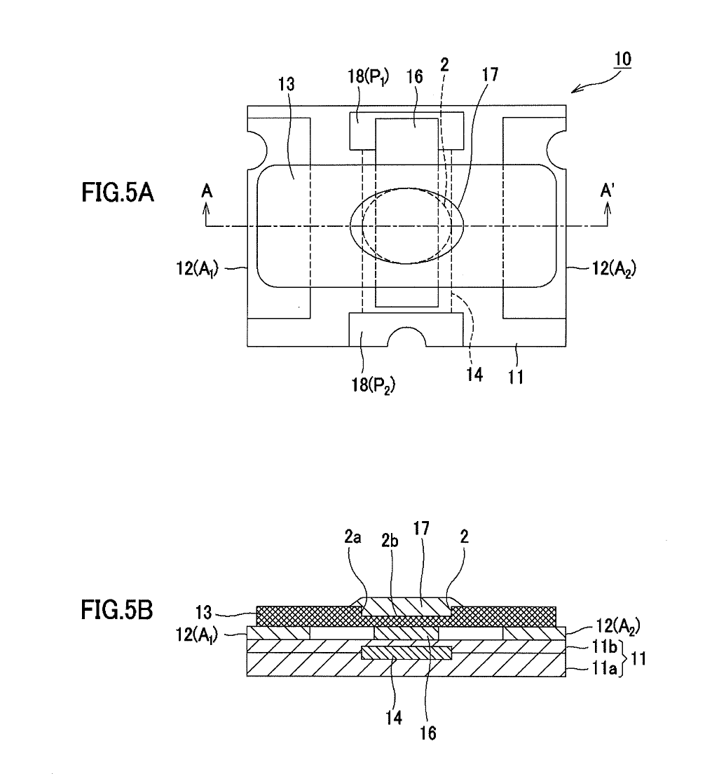

As illustrated in FIG. 5A and FIG. 5B, a depression portion is formed in an insulating layered substrate 11a to laminate the heating element 14 therein, and furthermore a layered substrate 11b is laminated on the layered substrate 11a and the heating element 14, whereby an insulating substrate 11 having the heating element 14 in the internal layer of the insulating substrate 11 can be configured. An internal heating-element electrode 16 is drawn out on the thus-configured insulating substrate 11, and electrodes 12 (A1) and 12 (A2) are formed in both ends of the insulating substrate, and furthermore a fusible conductor 13 is connected over from the internal heating-element electrode 16 to the electrodes 12 (A1) and 12 (A2), whereby a protection element 10 is configured. The heating element 14 and the fusible conductor 13 are arranged so as to make the insulating substrate 11 serve also as an insulating member, whereby the insulating member 15 illustrated in FIG. 1 and other figures can be omitted, and consequently the protection element 10 can be made still thinner. Furthermore, the layered substrate 11b as an upper layer having a thinner thickness yields good heat conduction and allows fusing characteristics to be improved.

As mentioned above, from the viewpoint of heat conduction, the fusible conductor 13 and the depression portion 2 thereof and the heating element 14 are preferably arranged so that the fusible conductor 13 and the depression portion 2 thereof are superposed above the heating element 14 via an insulator sandwiched between the fusible conductor 13 and the depression portion 2 thereof and the heating element 14, but, as explained below, it is essential only that the fusible conductor 13 and the depression portion 2 thereof and heating element 14 are thermally bonded, and the fusible conductor 13 and the depression portion 2 thereof may not be necessarily in a position to be superposed above the heating element 14.

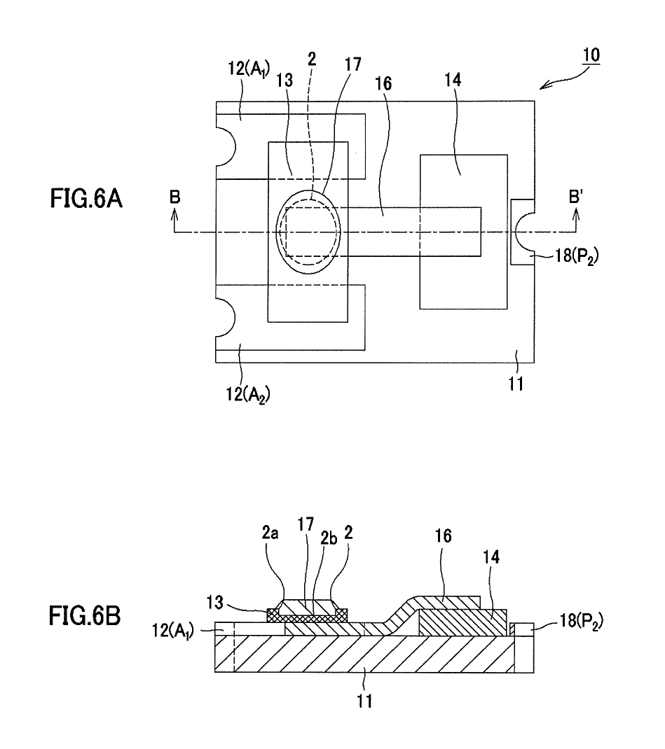

As illustrated in FIG. 6A and FIG. 6B, a heating element 14 may be arranged on an insulating substrate 11, and an internal heating-element electrode 16 may be drawn out on the insulating substrate 11, and a fusible conductor 13 may be connected over from the internal heating-element electrode 16 to electrodes 12 (A1) and 12 (A2). In this case, a depression portion 2 of the fusible conductor 13 is arranged not to be superposed above the heating element 14, and the depression portion 2 of the fusible conductor 13 and the heating element 14 are thermally bonded via the internal heating-element electrode 16. The heating element 14, the fusible conductor 13, and the insulating substrate 11 are not laminated in the height direction, whereby the protection element 10 can be made still thinner.

[Method for Using a Protection Element]

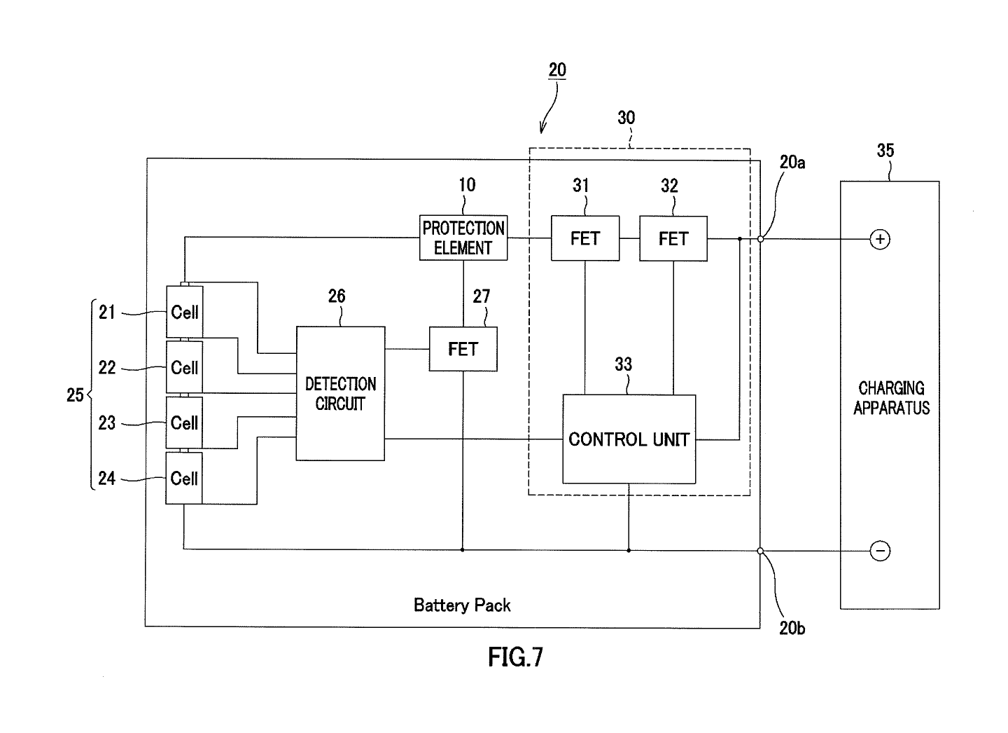

As illustrated in FIG. 7, the above-mentioned protection element 10 is used for a circuit in a battery pack of a lithium ion secondary battery.

For example, the protection element 10 is used by being incorporated into a battery pack 20 having a battery stack 25 comprising a total of four battery cells 21 to 24 of a lithium ion secondary battery.

The battery pack 20 comprises: the battery stack 25; a charge-and-discharge control circuit 30 configured to control charging and discharging of the battery stack 25; the protection element 10 according to the present invention, being configured to protect the battery stack 25 and the charge-and-discharge control circuit 30; a detection circuit 26 configured to detect the voltage of each of the battery cells 21 to 24; and a current control element 27 configured to control an operation of the protection element 10 depending on a detection result by the detection circuit 26.

The battery stack 25 is formed by serially connecting the battery cells 21 to 24 which requires a control for protection from overcharge and overdischarge states, and the battery stack 25 is removably connected to a charging apparatus 35 via a positive electrode terminal 20a and a negative electrode terminal 20b of the battery pack 20, and a charging voltage from the charging apparatus 35 is applied on the battery stack 25. The positive electrode terminal 20a and the negative electrode terminal 20b of the battery pack 20 charged by the charging apparatus 35 are connected to a battery-operated electronic device, whereby this electronic device can be operated.

The charge-and-discharge control circuit 30 comprises: two current control elements 31 and 32 serially connected on a current path flowing from the battery stack 25 to the charging apparatus 35; and a control unit 33 configured to control operations of the current control elements 31 and 32. The current control elements 31 and 32 each are configured with, for example, a field-effect transistor (hereinafter, referred to as FET), and a gate voltage is controlled by the control unit 33, whereby the current control elements 31 and 32 control the continuity and interruption of the current path of the battery stack 25 are controlled. The control unit 33 operates in response to an electric power supply from the charging apparatus 35, and, depending on a detection result by the detection circuit 26, when the battery stack 25 is in an overdischarge state or in an overcharge state, the control unit 33 controls the operations of the current control elements 31 and 32 are controlled thereby to interrupt the current path.

The protection element 10 is, for example, connected on the charge-and-discharge current path between the battery stack 25 and the charge-and-discharge control circuit 30, and the operation of the protection element 10 is controlled by the current control element 27.

The detection circuit 26 is connected to each of the battery cells 21 to 24, and detects a voltage value of each of the battery cells 21 to 24 and provides each of the voltage values to the control unit 33 of the charge-and-discharge control circuit 30. Furthermore, the detection circuit 26 outputs a control signal to control the current control element 27 when an overcharge voltage or an overdischarge voltage is detected in any one of the battery cells 21 to 24.

When, based on a detection signal outputted from the detection circuit 26, it is found that a voltage value of any of the battery cells 21 to 24 exceeds a predetermined overdischarge voltage or a predetermined overcharge voltage, the current control element 27 operates the protection element 10 and controls the charge-and-discharge current path of the battery stack 25 to be interrupted, without the switching operation of the current control elements 31 and 32.

The configuration of the protection element 10 in the battery pack 20 having the above-mentioned configuration will be specifically explained.

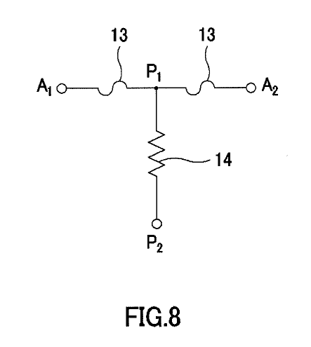

First, a protection element 10 according to the present invention has a circuit configuration as illustrated in FIG. 8, for example. That is, the protection element 10 has a circuit configuration comprising: a fusible conductor 13 having two electrodes 12 (A1) and 12 (A2) in both ends thereof; and a heating element 14 configured to pass electric current from the electrode 12 (A1) (or the electrode 12 (A2)) via the fusible conductor 13, an internal heating-element electrode 16 serving as a connecting point to the fusible conductor 13, and a heating element electrode 18 (P1), to another heating element electrode 18 (P2). Furthermore, in the protection element 10, for example, the fusible conductor 13 is serially connected on the charge-and-discharge current path, and the heating element 14 is connected to the current control element 27.

The protection element 10 having such circuit configuration achieves a further reduction in height, and also the protection element 10 can surely fuse the fusible conductor 13 on the current path by heat generation by the heating element 14.

[Method for Producing a Fusible Conductor having a Depression Portion]

To form a depression portion 2 on a fusible conductor 13, there may be used well-known processing techniques, such as opening by laser, opening by a pressing pin which is formed so as to fit the shape of the depression portion 2, and press molding.

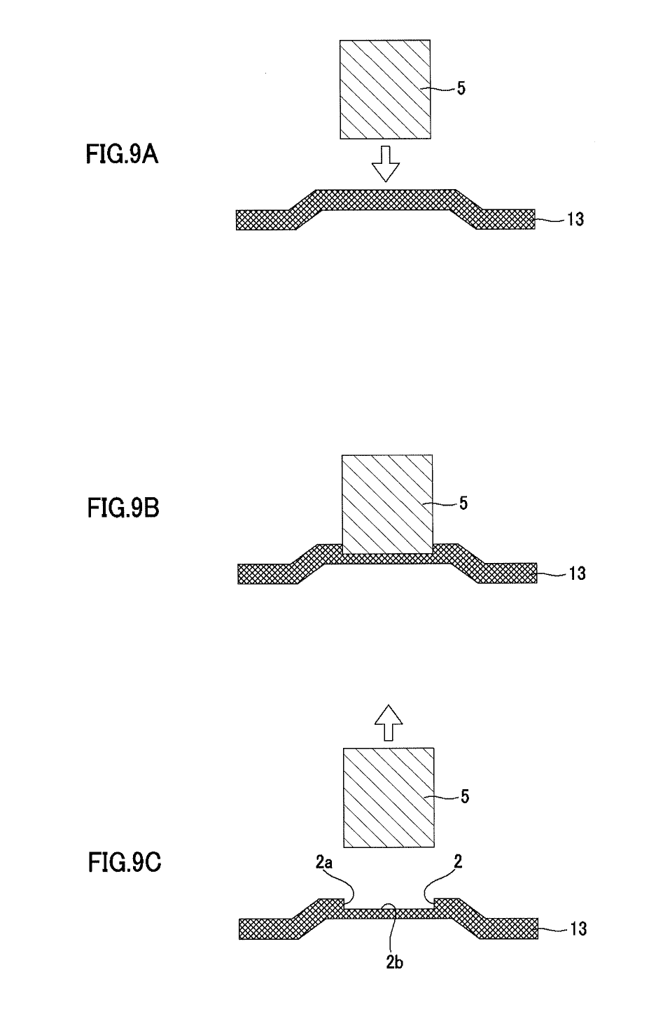

As illustrated in FIG. 9A, a position of the tip of the pressing pin 5 is arranged so as to be aligned with a predetermined portion of the fusible conductor 13, that is, a position in which the fusible conductor 13 is superposed above the heating element 14, and the pressing pin 5 is moved in the direction of the arrow to be pressed against the fusible conductor 13. The shape of the tip of the pressing pin 5 is, for example, cylindrical. As illustrated in FIG. 9B, a predetermined pressure is applied on the pressing pin 5, thereby pressing the tip of the pressing pin 5 against the fusible conductor 13 to a predetermined depth. As illustrated in FIG. 9C, the pressing pin 5 is drawn up in the direction of the arrow, thereby being separated from the fusible conductor 13. Thus, a hole portion as a cylindrical depression portion 2 having a wall portion 2a and a bottom portion 2b is formed in a position of the fusible conductor 13 in which the fusible conductor 13 is superposed above the heating element 14.

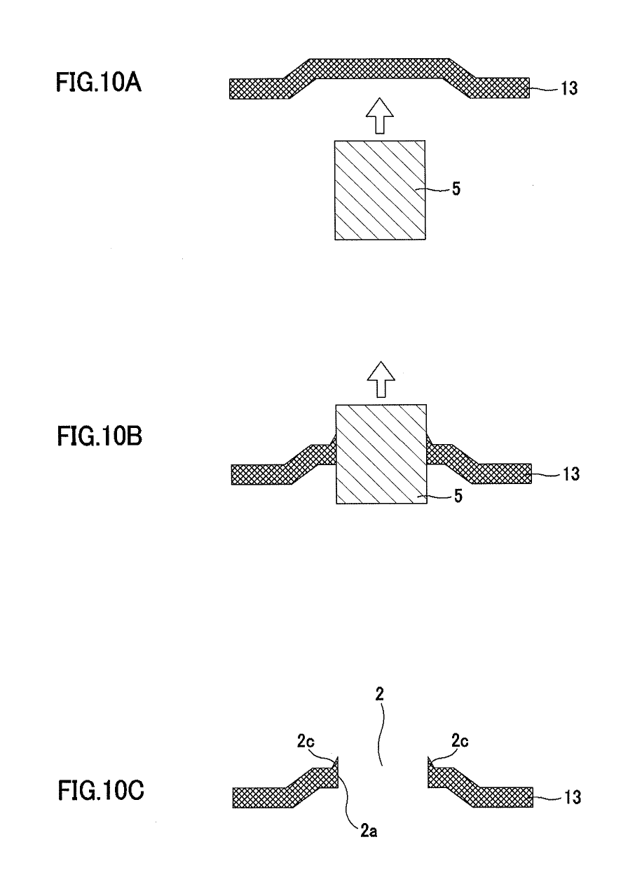

As illustrated in FIG. 10A, a pressing pin 5 is moved from beneath a fusible conductor 13 in the direction of the arrow and pressed against the undersurface of the fusible conductor 13. The shape of the tip of the pressing pin 5 is the same as that of the pressing pin illustrated in FIG. 9. As illustrated in FIG. 10B, furthermore the pressed pressing pin 5 is drawn up toward above the fusible conductor 13 and drawn out upward. As illustrated in FIG. 10C, a circular through hole having a wall portion 2a is formed in a position of the fusible conductor 13 in which the fusible conductor 13 is superposed above a heating element 14. The penetration of the pressing pin 5 allows a projecting wall portion 2c to be formed in the direction of the movement of the pressing pin 5.

The shape of the tip of the pressing pin 5, the pressure to press the pressing pin 5 against the fusible conductor 13, and the like are appropriately adjusted, and the ductility of the fusible conductor 13 as metal is made use of, whereby depression portions 2 of various shapes can be formed.

It goes without saying that, likewise, other well-known processing techniques, such as laser and press molding, can form depression portions 2 of various shapes.

[Modified Examples of Protection Element]

Hereinafter, form variations and the like of a depression portion 2 formed on a fusible conductor 13 will be explained. In the following explanation, the configuration of a protection element 10 illustrated in FIG. 1 in which an insulating member 15 is laminated will be described, but, it goes without saying that the following variations are applicable also to the configurations of protection elements illustrated in FIG. 4, FIG. 5, and FIG. 6.

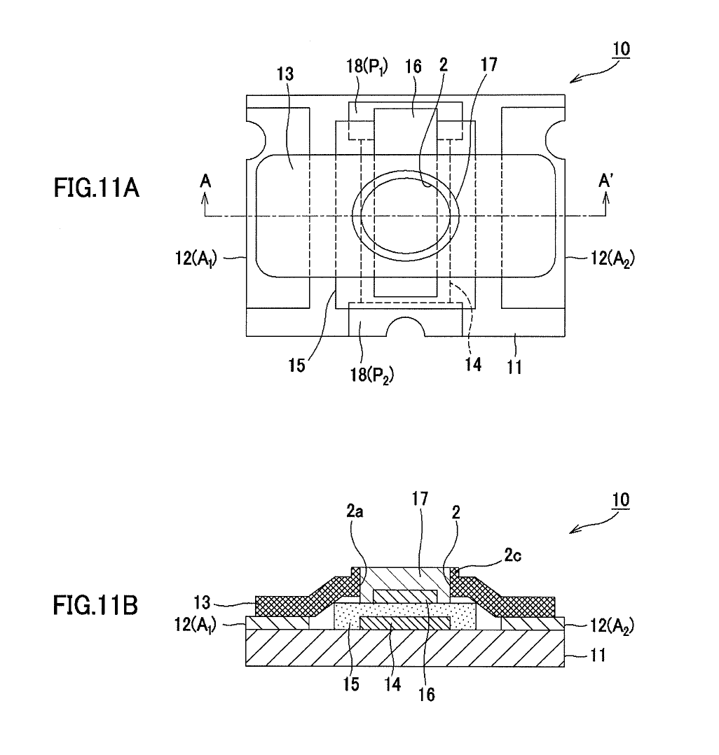

As illustrated in FIG. 11A and FIG. 11B, in the case where a depression portion 2 of a fusible conductor 13 is formed using the method explained in FIG. 10, a projecting wall portion 2c extending upward from the upper end of a wall portion 2a can be formed at the upper surface side of the fusible conductor 13, together with the wall portion 2a of a through hole. When a protection element 10 is configured using such fusible conductor 13, the depression portion 2 as a through hole is filled up with a flux 17, and thus, the molten state of the fusible conductor 13 due to the heat of a heating element 14 can be made uniform, whereby variations in fusing characteristics can be reduced. As explained in FIG. 10, the projecting wall portion 2c formed together with the through hole (the depression portion 2) allows the flux 17 to be more stably held in the depression portion 2.

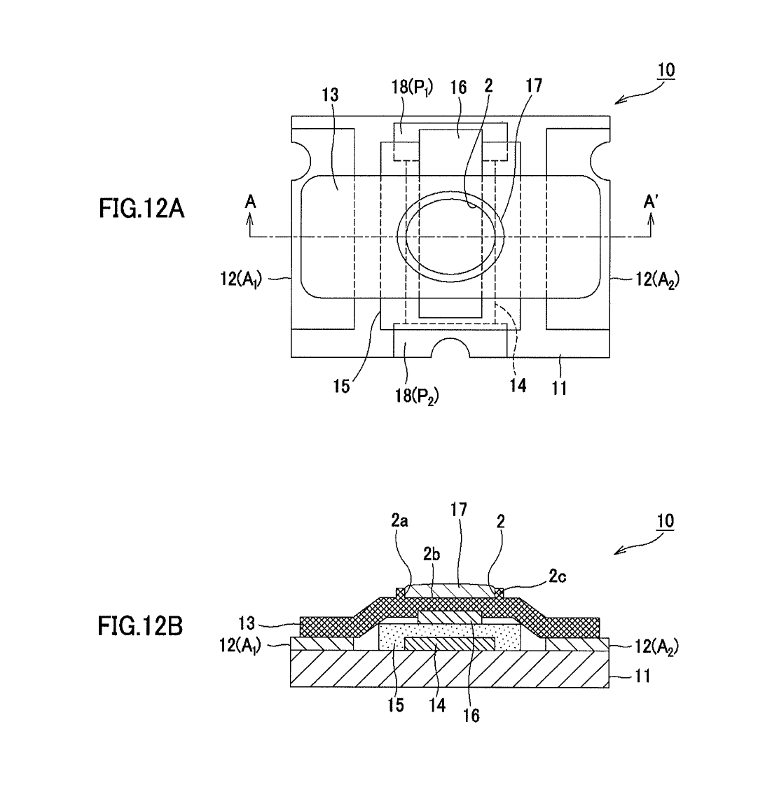

As illustrated in FIG. 12A and FIG. 12B, a depression portion 2 of a fusible conductor 13 may be formed only of a projecting wall portion 2c having a wall portion 2a.

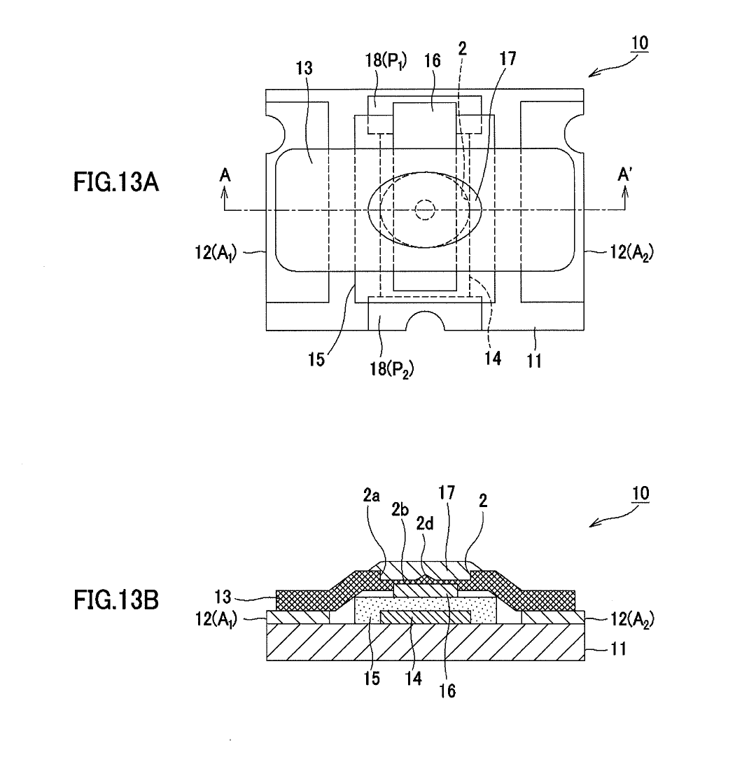

As illustrated in FIG. 13A and FIG. 13B, at the approximately center of a bottom portion 2b of a depression portion 2 of the fusible conductor 13, the depression portion 2 being cylindrically formed and having a wall portion 2a and the bottom portion 2b, there may be formed a projecting member 2d having an climb gradient from the circumference of the bottom portion 2b toward the center of the bottom portion 2b. Particularly, in the case where a flux 17 has a high viscosity, the flux 17 is hard to be filled up in the corners of the bottom portion 2b at the side the wall portion 2a (circumference side) of the bottom portion 2b, and accordingly there is a possibility of the occurrence of a void. Therefore, the projecting member 2d is provided around the center of the bottom portion 2b of the depression portion 2, thereby carrying away the flux 17 to the circumference of the bottom 2b, whereby filling performance can be improved. The projecting member 2d has a conical shape whose bottom is in contact with the bottom portion 2b, but, the shape is not limited to conical and may be hemispherical, or the like, and also a plurality of projecting members may be provided.

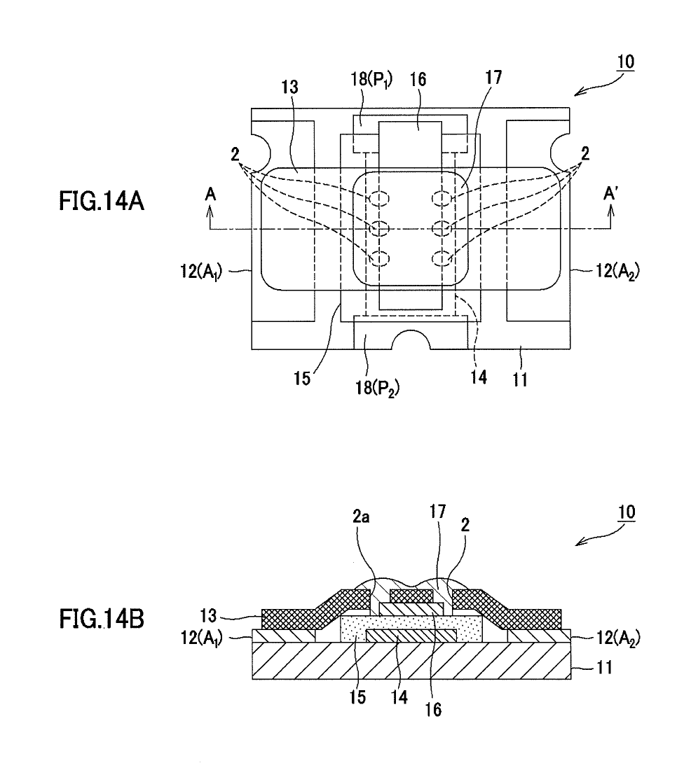

As illustrated in FIG. 14A and FIG. 14B, the number of the depression portions 2 formed in the fusible conductor 13 is not necessarily only one, but, a plurality of depression portions 2, for example, six depression portions 2 may be arranged. Thus, the arrangement of a plurality of depression portions 2 having small diameter enables a less amount of the flux 17 to be held in a predetermined position. Furthermore, a plurality of the depression portions 2 may be formed in arbitrary positions on the fusible conductor 13, and therefore, the depression portions 2 can be arranged effectively in a position to be superposed above a heating element 14 or in a position in which the fusible conductor 13 should be actually fuse, whereby the range of a position of holding the flux 17 is substantially expanded and thus it is possible to hold the flux 17 in a wider range. It goes without saying that the depression portion 2 is not limited to a through hole having a wall portion 2a like the one illustrated in FIG. 14, may be a hole portion having a wall portion and a bottom portion.

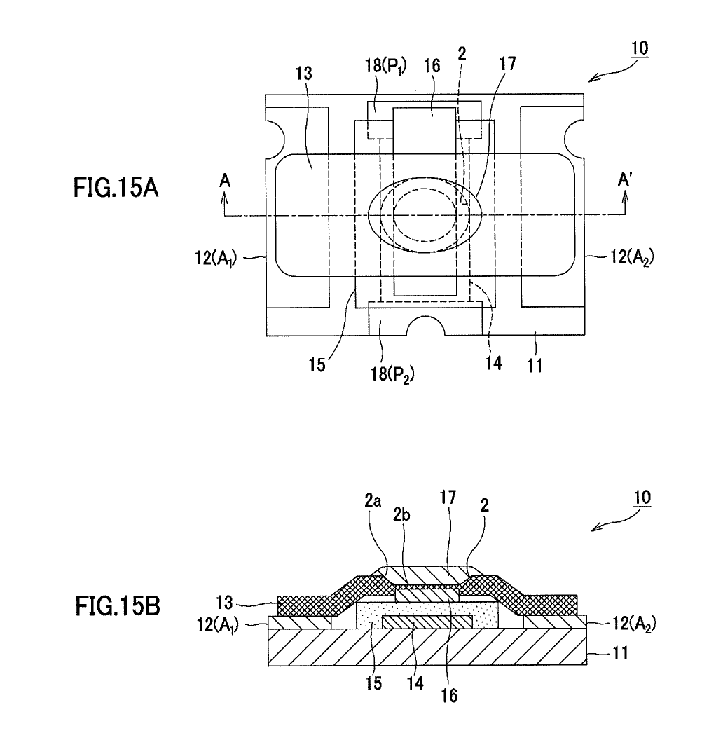

As illustrated in FIG. 15A and FIG. 15B, a depression portion 2 of a fusible conductor 13 may be a hole portion having a wall portion 2a and a bottom portion 2b and having an inverted conical shape being such that the diameter is increasing from the bottom portion 2b toward the opening side. The hole portion having an inverted truncated cone shape allows a flux 17 to be sufficiently filled up in the depression portion 2, even in the circumference of the bottom portion 2b of the depression portion 2. Therefore, the occurrence of a void after the filling-up of the flux 17 can be controlled, and the flux 17 can be uniformly fixed.

It should be noted that, by making the area of the bottom portion 2b of the depression portion 2 very small, a depression portion 2 having an inverted conical shape may be formed. Alternatively, by penetrating the bottom portion 2b, a through hole having an inverted truncated cone shape may be formed.

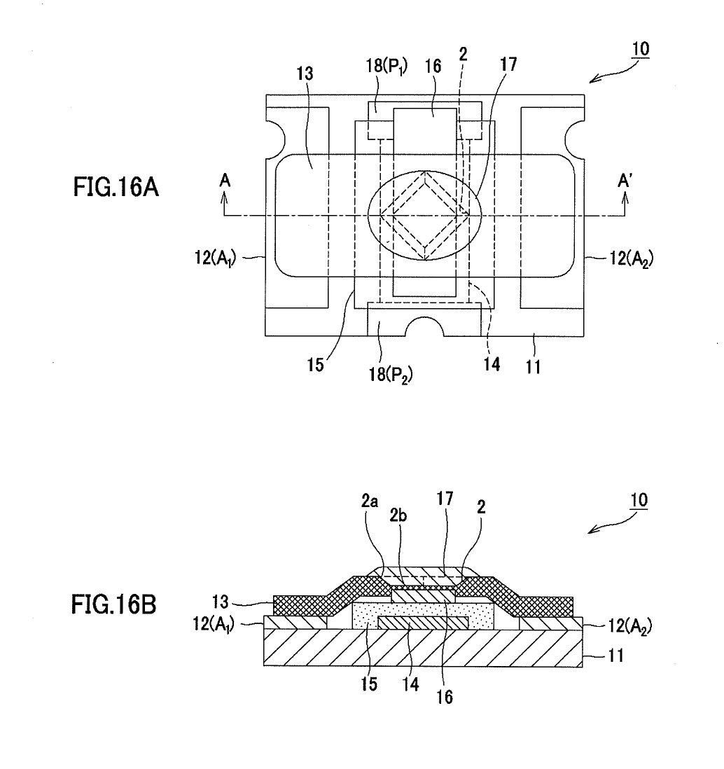

From the viewpoint of the filling-up of the depression portion 2 with the flux 17, the shape of the opening and the shape of the bottom of the depression portion 2 are preferably circular or elliptical, but, it goes without saying that the opening and the bottom may have an arbitrary shape. As illustrated in FIG. 16A and FIG. 16B, the depression 2 may be formed so as to have a rhombic shape, a square shape, a rectangular shape or other polygonal shapes. As mentioned above, as illustrated in FIG. 16, the shape of the depression 2 is not limited to an inverted truncated pyramid shape in which the diameter is increasing from the bottom portion 2b toward the opening side, but, may be an inverted pyramid shape, or an inverted truncated pyramid shape in which the bottom portion 2b is penetrated through.

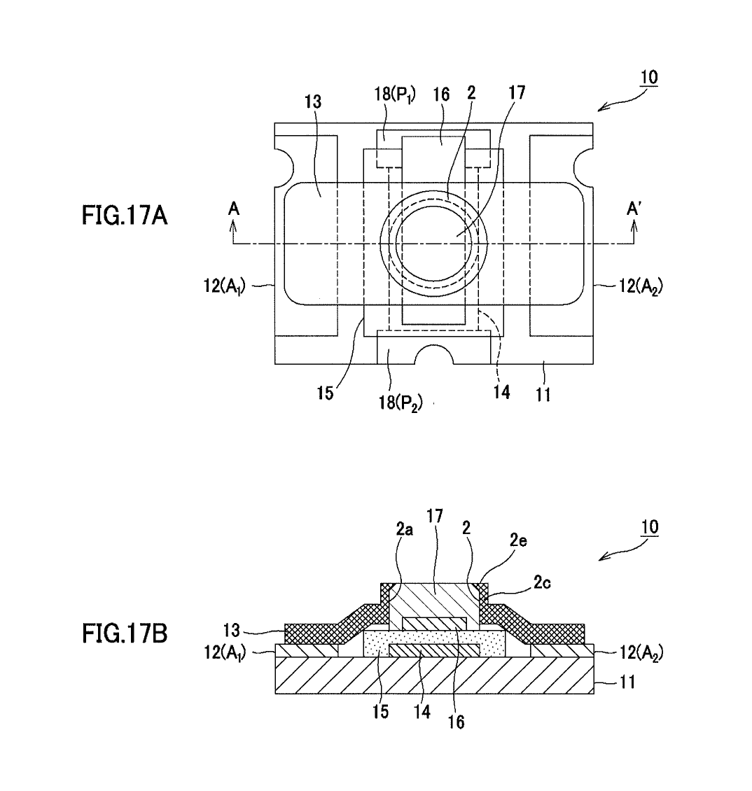

As illustrated in FIG. 17A and FIG. 17B, a depression portion 2 being a through hole having a wall portion 2a may have a projecting wall portion 2c formed upward in the circumference of the opening of the depression 2, and a flux holding portion 2e provided at the upper end of the projecting wall portion 2c so as to extend in the form of a wall toward the inside of the diameter direction of the opening. As mentioned above, when the depression portion 2 has the projecting wall portion 2c, the property of holding the flux 17 is improved, meanwhile, when the depression portion 2 has the flux-holding portion 2e, even if the protection element 10 is mounted at a portion tilted from the horizontal position, the property of holding the flux 17 is maintained, whereby the occurrence of a void can be controlled.

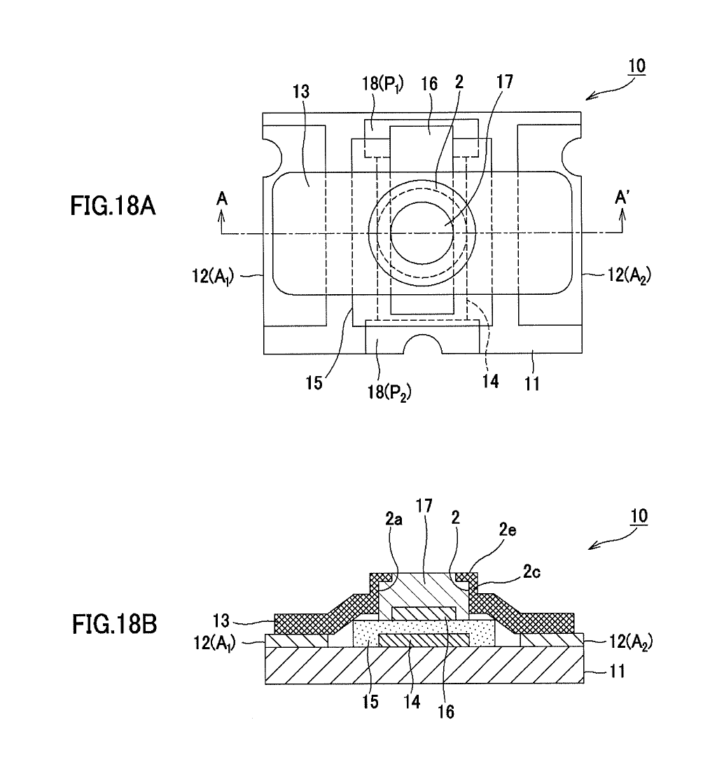

As illustrated in FIG. 18A and FIG. 18B, when a flux-holding portion 2e is formed so as to be longer, the property of holding a flux 17 can be improved.

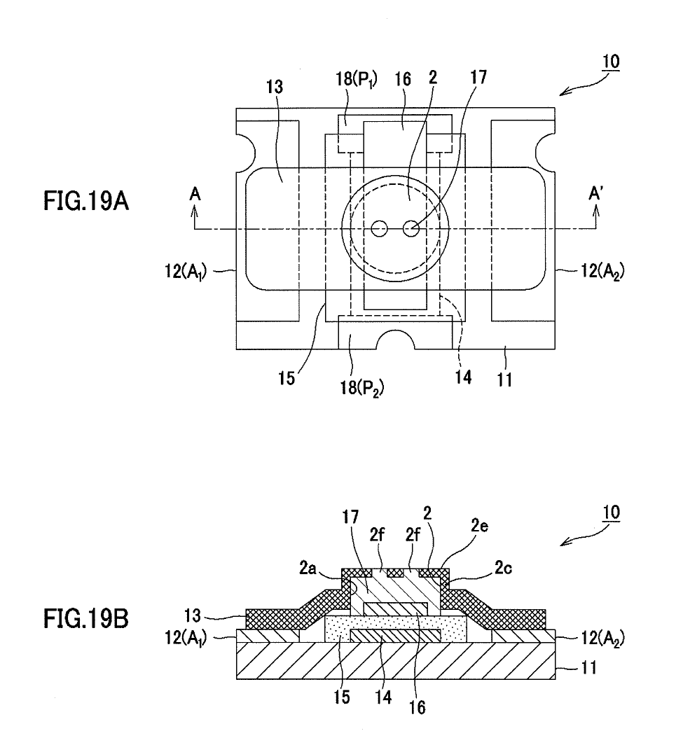

As illustrated in FIG. 19A and FIG. 19B, a flux-holding portion 2e may be further extended and formed so as to close the upper opening of the depression portion 2, with an opening portion 2f remaining unclosed. The formation of the two opening portions 2f and 2f enables a flux 17 to be poured in from one of the opening portions 2f, meanwhile air to be discharged from another one of opening portions 2f, and thus the occurrence of a void can be more certainly controlled.

The depression portion 2 formed as shown in Modified Examples illustrated in FIG. 17 to FIG. 19 allows a more amount of a flux 17 to be accommodated in the depression portion 2, and therefore is suitable for a protection element having a large current-capacity.

The depression portions in Modified Examples illustrated in FIG. 17 to FIG. 19 can be formed by the above-mentioned methods (explained in FIG. 9 and FIG. 10). For example, as illustrated in FIG. 10, a pressing pin 5 is pressed against the undersurface of a fusible conductor 13 at a predetermined pressure, and, without making the pressing pin 5 penetrates through the fusible conductor 13 and with making use of the ductility of the fusible conductor 13 as a metal, a projecting wall portion 2c and a flux holding portion 2e are formed simultaneously. Then, using a pin having a smaller diameter than the diameter of the tip of the pressing pin 5, a through hole can be formed. It goes without saying that a depression portion 2 can be formed by using any other well-known method.

### REFERENCE SIGNS LIST

1 . . . cover, 2 . . . depression portion, 2a . . . wall portion, 2b . . . bottom portion, 2c . . . projecting wall portion, 2d . . . projecting member, 2e . . . flux holding portion, 2f . . . opening portion, 3 . . . projecting portion, 5 . . . pressing pin, 10 . . . protection element, 11 . . . insulating substrate, 11a, 11b . . . layered substrates, 12 (A1), 12 (A2) . . . electrodes, 13 . . . fusible conductor, 14 . . . heating element, 15 . . . insulating member, 16 . . . internal heating element electrode, 17 . . . flux, 18 (P1), 18 (P2) . . . heating element electrodes, 20 . . . battery pack, 20a . . . positive electrode terminal, 20b . . . negative electrode terminal, 21 to 24 . . . battery cells, 25 . . . battery stack, 26 detection circuit, 27, 31, 32 . . . current control elements, 30 . . . charge-and-discharge control circuit, 33 . . . control unit, and 35 . . . charging apparatus.

1. A protection element, comprising:
an insulating substrate;
a heating element laminated on the insulating substrate;
first and second electrodes;
an internal heating-element electrode electrically connected to the heating element and a current path between the first and the second electrodes;
a fusible conductor connected over from the internal heating-element electrode to the first and the second electrodes, fusing the current path between the first and second electrodes by heating, and having a depression portion in a position to be thermally coupled to the heating element; and
a flux applied to fill up the depression portion,
wherein the depression portion is formed and opened at a side for applying the flux.

2. The protection element according to claim 1, wherein the depression portion is a hole portion having a wall portion and a bottom portion.

3. The protection element according to claim 2, wherein the hole portion is formed to have any of a cylindrical shape, an inverted conical shape, an inverted truncated cone shape, a prism shape, an inverted pyramid shape, and an inverted truncated pyramid shape.

4. The protection element according to claim 1, wherein the depression portion is a through hole penetrating through the fusible conductor.

5. The protection element according to claim 4, wherein the through hole is formed to have any of a cylindrical shape, an inverted truncated cone shape, a prism shape, and an inverted truncated pyramid shape.

6. The protection element according to claim 1, the protection element further comprising a projecting wall portion formed along a circumference of the depression portion in an upper direction in which the depression portion is open.

7. The protection element according to claim 6, the protection element further comprising a flux-holding portion formed in a wall shape from a tip of the projecting wall portion toward a diameter direction and a center direction of the depression portion.

8. The protection element according to claim 7, wherein the flux-holding portion covers a whole of opening in an upper face of the depression portion and has at least one or more opening for the flux.

9. The protection element according to claim 2, wherein the hole portion further comprises a projecting member having an climb gradient from a circumference of the bottom portion of the hole portion toward a center portion of the bottom portion.

10. The protection element according to claim 1, wherein the depression portion of the fusible conductor is formed in a position to be superposed above the heating element.

11. The protection element according to claim 2, wherein the depression portion of the fusible conductor is formed in a position to be superposed above the heating element.

12. The protection element according to claim 3, wherein the depression portion of the fusible conductor is formed in a position to be superposed above the heating element.

13. The protection element according to claim 4, wherein the depression portion of the fusible conductor is formed in a position to be superposed above the heating element.

14. The protection element according to claim 5, wherein the depression portion of the fusible conductor is formed in a position to be superposed above the heating element.

15. The protection element according to claim 6, wherein the depression portion of the fusible conductor is formed in a position to be superposed above the heating element.

16. The protection element according to claim 7, wherein the depression portion of the fusible conductor is formed in a position to be superposed above the heating element.

17. The protection element according to claim 8, wherein the depression portion of the fusible conductor is formed in a position to be superposed above the heating element.

18. The protection element according to claim 9, wherein the depression portion of the fusible conductor is formed in a position to be superposed above the heating element.
